(19) United States
(12) Patent Application Publication
(10) Pub. No.: US 2008/0057460 A1
(43) Pub. Date: Mar. 6, 2008

(54) Anchor-based fixed retainers

(76) Inventor: Craig S. Hicks, Frisco, TX (US)

Correspondence Address: CHRISTIE, PARKER & HALE, LLP, PO BOX 7068, PASADENA, CA, 91109-7068, US

(21) Appl. No.: 11/513,703

(22) Filed: Aug. 30, 2006

(51) Int. Cl. A61C 3/00

(52) U.S. Cl. 433/20

(57) ABSTRACT

Anchor-based fixed retainers are generally discussed herein with particular discussions extended anchor-based fixed retainers for maintaining teeth alignment having a plurality of anchors each with a bore and adapted to directly bond to a tooth. Aspects of the present invention include utilizing a plurality of anchors along with a metal wire to form a fixed retainer with each anchor comprising a bore passing through a body and subjacent a top surface.

Anchor-based fixed retainers are generally discussed herein with particular discussions extended anchor-based fixed retainers for maintaining teeth alignment for a dental arch having a plurality of anchors each comprising a bore and adapted to directly bond to a tooth.

### BACKGROUND

Dental braces are worn to align the teeth. After successful orthodontic treatment (i.e., after the braces are removed), a retainer is typically worn to keep the teeth in the aligned position. Retainers are provided to prevent movement of the teeth after completion of orthodontic treatment.

Generally speaking, there are two types of retainers: removable retainers and fixed retainers. The present invention and the embodiments disclosed herein relate to fixed retainers. Prior art fixed retainers are fitted behind the front teeth to prevent teeth movement and rotation. This process usually involves bonding a thin flexible wire directly to the lingual surface of the upper and lower teeth. Fixed retainers are designed to be worn over a prolonged period of time, typically months or years, and if necessary for life.

The problems with prior art fixed retainers include difficulties associated with bending a wire to fit the contour of the teeth, the application of bonding composites is time consuming and the amount on each tooth is inconsistent at best. Prior art fixed retainers also require impressions, lab fees, fittings, remakes, and chair time, which contribute to the overall cost of mounting fixed retainers to a patient.

Accordingly, there is a need for an anchor-based fixed retainer that simplifies the application thereof to thereby lower fees and costs.

### SUMMARY

Aspects of the present invention may be implemented by providing a fixed retainer system for oral application comprising a plurality of anchors including a first anchor and an Nth anchor, each anchor comprising a body comprising a base, a top surface, and a bore formed through the body and subjacent the top surface; a wire having two ends passing through each of the bores, and wherein one of the two ends is bonded to the first anchor and the other end is bonded to the Nth anchor.

The present invention includes a method for assembling an anchor-based fixed retainer to a dental arch comprising: obtaining a plurality of anchors, including a first anchor and an Nth anchor, each comprising a body comprising a base, a top surface, and a bore formed through the body and subjacent the top surface; obtaining a metal wire having a first free end and a second free end; passing the metal wire through the bores of the plurality of anchors; bonding the base of the first anchor to a first tooth and bonding the base of the Nth anchor to a second tooth; bonding the plurality of anchors, less the first anchor and the Nth anchor, to a set of teeth located between the first tooth and the second tooth; and bonding the first free end to the first anchor and bonding the second free end to the Nth anchor.

Yet according to other aspects of the present invention, there is provided a method for assembling an anchor-based fixed retainer to a dental arch comprising: obtaining a plurality of anchors, including a first anchor and an Nth anchor, each comprising a body comprising a base, a top surface, and a bore formed through the body and subjacent the top surface; bonding the base of each anchor to a set of teeth while aligning the bore to be approximately co-planar with an adjacent bore; obtaining a metal wire having a first free end and a second free end; passing the metal wire through the bores of the plurality of anchors; and bonding the first free end to the first anchor and the second free end to the Nth anchor.

Still yet in accordance with aspects of the present invention, a undulating base may be incorporated to enhance bonding between the anchor and a tooth, which may include a micro-etched surface or a surface having a wire mesh secured thereto.

In yet other aspects of the present invention, the anchors have a uniform configuration, such as all rectangular shape, all oval shape, all triangular shape, or all resembling a slice of a sphere.

Other aspects and features of the fixed retainers provided herein may be better appreciated as the same become better understood with reference to the specification, claims, and appended drawings.

### BRIEF DESCRIPTION OF THE DRAWINGS

The appended drawings include:

FIG. 1, is a semi-schematic view of a dental arch having a fixed retainer provided in accordance with aspects of the present invention comprising a plurality of anchors attached thereto;

FIG. 2 is a cross-sectional side-view of an anchor of FIG. 1, shown without a wire passing through the bore;

FIG. 3 is a top view of one of the anchors of FIG. 1;

FIG. 4 is a bottom view of the anchor of FIG. 3;

FIG. 5 is a top view of an alternative anchor provided in accordance with aspects of the present invention;

FIG. 6 is a top view of yet another alternative anchor provided in accordance with aspects of the present invention;

FIG. 7 is a semi-schematic side view of a tooth having an anchor mounted thereto; and

FIG. 8 is a semi-schematic side view of a different tooth having an anchor mounted thereto.

### DETAILED DESCRIPTION

The detailed description set forth below in connection with the appended drawings is intended as a description of the presently preferred embodiments of anchor-based fixed retainers provided in accordance with aspects of the present invention and is not intended to represent the only forms in which the present invention may be constructed or utilized. The description sets forth the features and the steps for constructing and using the anchor-based fixed retainers of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like or similar elements or features.

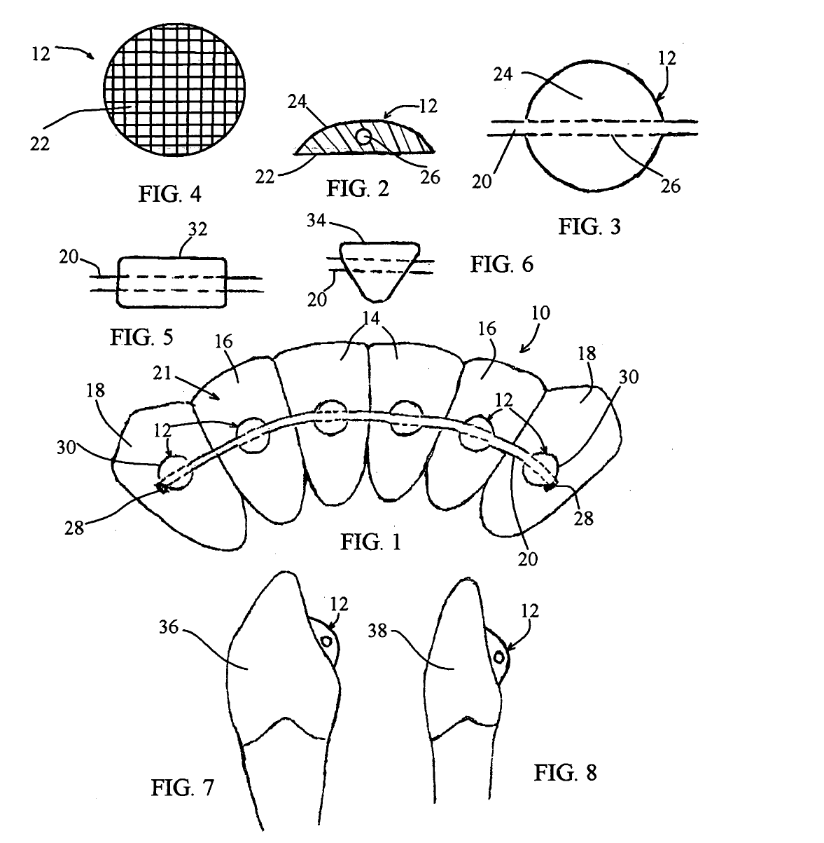

Referring now to FIG. 1, a partial view of a mandibular arch 10 is shown having a plurality of anchors 12 provided in accordance with aspects of the present invention bonded thereto. In one exemplary embodiment, the anchors 12 are applied to the central 14 and lateral 16 incisors and cuspids 18 of the mandibular arch only. Obviously, the anchors 12 may also be applied to the same set of teeth of the maxillary arch (not shown). A thin flexible wire 20 passes through the anchors 12 for holding or fixing teeth movement, thus forming a fixed retainer system 21. The anchors 12 are each bonded to the backside of the teeth using a prior art bonding agent, such as Tetric Flow or Heliosit Orthodontic material. Although only six anchors 12 are shown, a plurality of anchors, along with a wire, forming a fixed retainer system may have a first anchor through an Nth anchor, wherein the Nth anchor represents the last anchor in the series, which may be one of sixth through fortieth anchor. Preferably the Nth anchor is an even number.

With reference now to FIG. 2 in addition to FIG. 1, a semi-schematic cross-sectional side view of an anchor 12 provided in accordance with aspects of the present invention is shown. In one exemplary embodiment, the anchor 12 comprises a base surface 22 for bonding to a tooth and a top surface 24 configured for contact such as with the tongue. Accordingly, the top surface 24 preferably incorporates a smooth contour with no sharp edges. In one specific embodiment, the anchor 12 resembles a quarter sphere or a slice of a sphere. In an alternative embodiment, the curvature is not of a true sphere in that the mid section is enlarged to accommodate a bore 26.

A bore 26 is formed through the anchor 12 to permit threading the wire 20 therethrough. In one exemplary embodiment, the bore 26 has a uniform dimension, i.e., the same diameter or width throughout. However, one or both entrance points to the bore 26 may be flared or enlarged to facilitate threading the wire 20 through the bore. The bore 26 may be round, rectangular, or square, which preferably corresponds to the shape of existing prior art arch wires, which come in round, square, and rectangular shapes. The anchors 12 for the central and lateral incisors and the cuspids are preferably the same, which eliminates the hassle of maintaining different sizes and bracket types when using the anchors to form a retainer as provided herein.

In one exemplary embodiment, the anchor 12 is symmetrical, including the position of the bore 26 about a centerline. The anchor 12 is preferably sized sufficiently small to avoid crowding the tongue space. As such, the anchors are not expected to encroach upon the lingual gingival edges when mounted to the teeth. Also because of their relative sizes compared to the teeth, the base surface 22 of each anchor 12 may be generally flat. However, the base surface may have an undulating contour to fit within the ridges of the teeth.

As discussed above, the anchors 12 are configured to be bonded directly to the lingual surface of the teeth. After the anchors 12 are bonded to the teeth, a prior art dental wire 20 is passed through the bore 26 formed at the center of each anchor. The wire 20 has pre-selected gauge and tensile strength for resisting bending or movement of the teeth of their natural tendency to move or rotate. In one exemplary embodiment, a Dentaflex co-axial 0.018″, Dentaflex multi-stranded 0.018″, or Respond Dead Soft straight 0.0175″ wire may be used. However, other prior art wires selected from a trained provider may be used without deviating from the spirit and scope of the present invention. As non-limiting examples, wires made from titanium memory wire, stainless steel, chromium cobalt wire, twisted wire, co-ax wire, woven wire, natural arch wire, Bonwill Hawley arch wire, and Brader arch wire are all usable with the anchors described herein. After the wire 20 is threaded through the anchors 12, its two ends 28 are trimmed and bonded to the two end anchors 30. As is readily apparent, it is much easier to pass the wire 20 through the anchors 12 than to bend the wire so that it contacts each individual tooth to then be bonded to the teeth.

In an alternative embodiment, the wire 20 is threaded through a plurality of anchors 12 prior to bonding the anchors 12 to the teeth. This is accomplished by passing the wire 20 through several anchors 12, such as six to fourteen anchors, and then bending one end 28 of the wire 14 so that the end anchor 30 next to the bent end 28 does not fall off. The two end anchors 30 are then bonded to the teeth prior to bonding the anchors 12 located in between the two end anchors 30 to the teeth. After the two end anchors 30 are bonded, the middle anchors 12 are adjusted (up and down, left and right so that the bores 26 align) and bonded to the teeth. The other end 28 of the wire 20, i.e., the free end of the wire that hasn't been bent, is then pulled/stretched and then bent and trimmed to size. The two ends 28 of the wire 20 are then bonded to the two end anchors 30 to eliminate sharp edges.

In an alternative embodiment, instead of bending one of the ends of the wire 20 to prevent the end anchor, and the other anchors, from being displaced off of the wire, a small clamp or other holding means (not shown) may be used to temporarily pinch the one end. After the plurality of anchors 12 are bonded to the teeth, both ends of the wire may be manipulated, such as pulled or stretched, to facilitate completion of the wire to the end anchors 30.

FIG. 3 is a top view of one of the anchors 12 shown in FIG. 1 with hidden lines representative of the bore 26 shown as dashed lines. The wire 20 and the bore 26 are preferably sized to have a 2 mils to 30 mils total tolerance with 2 mils to 20 mils total tolerance being more preferred.

FIG. 4 is an underside view of the anchor 12 of FIG. 3, which shows the base surface 22 of the anchor. In one exemplary embodiment, the base surface 22 incorporates a mesh material, which may be separately welded or bonded to the base. The mesh material is available from Unitek Corporation of Monrovia, Calif. The mesh material facilitates bonding between anchor 12 and the tooth. However, a smooth base may be incorporated, i.e., without the mesh material, which is less effective in retaining the bonding agent than one having a mesh base. When a smooth base is used, superbond adhesives are preferably used. One such superbond adhesive is known as Panavia Ex® dental adhesive.

In one exemplary embodiment, the anchors 12 are each formed by metal injection, preferably from stainless steel, such as 17-4 stainless steel. The base surface 22 is then micro-etched to form an array of bumps or protrusions using prior art etching methods. These singularly formed anchors 12 will therefore have prepped base surfaces for facilitating bonding to the teeth without the need to separately mount the mesh material. Obviously, other materials may be used to form the anchors provided they are sufficiently rigid to resist breakage and torquing and are compatible with the bonding material. As examples, in addition to stainless steel, which is most preferred, steel alloy, rigid plastic, and a combination metal and plastic may be used to form the anchors.

Although the preferred anchor shape is round, as shown in FIGS. 1 and 3, alternatively, an anchor may have a rectangular shape 32 (FIG. 5) or a triangular shape 34 (FIG. 6). Other anchor shapes may be incorporated as well, including a polygon shape, an oval, and an irregular shape.

FIGS. 7 and 8 depict two different anchors 12 mounted on two different tooth 36, 38. The positioning/location of the anchors may vary from tooth to tooth, as depicted in FIGS. 7 and 8. Thus, for example, the distance between the incisal of the central incisor and the anchor bonded thereto may be different than the same two points on the lateral incisor. The alignment may also differ between individuals to be treated and the shape of the particular individual's teeth. Each anchor may be shifted up and down and side-to-side to fit within the contour of the particular tooth. A dental bonding agent should be sufficient to take up the slack or gap between the lingual tooth surface and the base surface of the anchor.

While the anchors 12 provided in accordance with aspects of the present invention have been described in connection with their use as a fixed retainer system 21 following successful orthodontic treatment, the retainer system may also be used by other specialists for their ease of application to a dental arch without the associated impressions, lab fees, fittings, remakes, chair time, etc. As examples, periodontists may use the fixed retainer system 21 as provided herein to stabilize mobile teeth and oral and plastic surgeons may use the fixed retainer system to stabilize the teeth after trauma in emergency rooms.

Although limited embodiments of the fixed retainer systems and their components have been specifically described and illustrated herein, many modifications and variations will be apparent to those skilled in the art. For example, the anchors may be made from a material that resembles the color of the teeth, be use with other prior art brackets, incorporate appendages for use with ligatures, and, although less preferred, be mounted to the buccal surface of the teeth. Furthermore, it is understood and contemplated that features specifically discussed for one anchor or retainer system may be adopted for inclusion with another anchor or system, provided the functions are compatible. For example, a round anchor may be used with a triangular shape anchor when forming the fixed retainer system. Accordingly, it is to be understood that the fixed retainer systems and their components constructed according to principles of this invention may be embodied other than as specifically described herein. The invention is also defined in the following claims.

1. A fixed retainer system for oral application after orthodontic treatment to align the teeth comprising a plurality of anchors including a first anchor and an Nth anchor, wherein each anchor is applied onto the lingual surface of a tooth, each anchor comprising a body comprising a base, a top surface, and a bore formed through the body and subjacent the top surface; a wire having two ends passing through each of the bores, and wherein one of the two ends is bonded to the first anchor and the other end is bonded to the Nth anchor.

2. The fixed retainer system of claim 1, wherein the Nth anchor is a sixth anchor.

3. The fixed retainer system of claim 1, wherein the wire is a multi-strand metal wire.

4. The fixed retainer system of claim 1, wherein at least one of the anchors resembles a slice of a sphere.

5. The fixed retainer system of claim 1, wherein the plurality of anchors have substantially identical cross-sections.

6. The fixed retainer system of claim 1, wherein at least one of the anchors comprises a base having a plurality of protrusions.

7. The fixed retainer system of claim 1, wherein at least one of the anchors comprises a base having a wire mesh attached thereto.

8. A method for assembling an anchor-based fixed retainer to a dental arch after orthodontic treatment to align the teeth comprising:
obtaining a plurality of anchors, including a first anchor and an Nth anchor, each comprising a body comprising a base, a top surface, and a bore formed through the body and subjacent the top surface;
obtaining a metal wire having a first free end and a second free end;
passing the metal wire through the bores of the plurality of anchors;
bonding the base of the first anchor to the lingual surface of a first tooth and bonding the base of the Nth anchor to the lingual surface of a second tooth;
bonding the plurality of anchors, less the first anchor and the Nth anchor, to the lingual surface of a set of teeth located between the first tooth and the second tooth; and
bonding the first free end to the first anchor and bonding the second free end to the Nth anchor.

9. The method of claim 8, wherein the plurality of anchors have similar cross-sectional configuration.

10. The method of claim 8, wherein the first free end is bent prior to bonding the first anchor to the first tooth.

11. The method of claim 10, wherein the second free end is pulled prior to bonding the second free end to the Nth anchor.

12. The method of claim 8, wherein the metal wire is a multi-stranded wire.

13. The method of claim 8, wherein the plurality of anchors comprises six anchors.

14. The method of claim 8, wherein at least one of the anchors comprises a shape resembling a slice of a sphere.

15. The method of claim 8, wherein the base surface of at least one of the anchors comprises a plurality of protrusions.

16-20. (canceled)
